(19) United States
(12) Patent Application Publication
(10) Pub. No.: US 2023/0065036 A1
(43) Pub. Date: Mar. 2, 2023

(54) OPTICAL DEVICE AND OPTICAL COMMUNICATION APPARATUS

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 17/845,328

(22) Filed: Jun. 21, 2022

(30) Foreign Application Priority Data
Aug. 30, 2021 (JP) 2021-140081

(51) Int. Cl. G02F 1/225; G02F 1/21

(52) U.S. Cl. CPC G02F 1/2255; G02F 1/212

(57) ABSTRACT

An optical device includes a rib optical waveguide that is a thin-film lithium niobate (LN) crystal formed of a thin-film LN substrate, and a buffer layer that is laminated on the optical waveguide. The optical device further includes an electrode that is laminated on the buffer layer, and sub electrodes that are arranged parallel to the electrode on the buffer layer, and attract a charge in the optical waveguide in accordance with electrification.

### CROSS-REFERENCE TO RELATED APPLICATION

This application is based upon and claims the benefit of priority of the prior Japanese Patent Application No. 2021-140081, filed on Aug. 30, 2021, the entire contents of which are incorporated herein by reference.

### FIELD

The embodiments discussed herein are related to an optical device and an optical communication apparatus.

### BACKGROUND

A conventional optical modulator includes, for example, optical waveguides that are arranged on a substrate and a modulation unit that is arranged in the vicinity of the optical waveguides. The modulation unit includes a signal electrode and a ground electrode, and if voltage is applied to the signal electrode, electric fields are generated in the optical waveguides, refractive indices of the optical waveguides are changed by the electric fields in the optical waveguides, and a phase of light is changed. The optical waveguides constitute Mach-Zehnder interferometers, and optical output is changed due to a phase difference of light between the optical waveguides.

In the optical modulator, for example, Mach-Zehnder interferometers for four channels are integrated. Each of the Mach-Zehnder interferometers includes a radio frequency (RF) modulation unit and a direct current (DC) modulation unit. A high-frequency signal with a bandwidth of, for example, dozens of GHz is input to an electrode of the RF modulation unit, and high-speed modulation is performed. Further, bias voltage is applied to an electrode of the DC modulation unit, and bias voltage is adjusted such that ON/OFF of an electrical signal corresponds to ON/OFF of an optical signal.

The optical waveguides of the optical modulator constitute, for example, Mach-Zehnder interferometers, and output, for example, IQ signals that are x- and y-polarized due to a phase difference of light among the plurality of optical waveguides that are arranged in parallel. Further, outputs of each two of the four channels are multiplexed such that two IQ signals are formed, and one of the two IQ signals is subjected to polarization rotation, further subjected to dual-polarization by a polarization beam combiner, and then output.

In contrast, as the optical waveguide, for example, a diffused optical waveguide is known that is formed at a position that does not overlap with the signal electrode by diffusing a metal, such as titanium, from a surface of the substrate,. FIG. 12 is a schematic cross-sectional view illustrating an example of a DC modulation unit 100 of a conventional optical modulator. The DC modulation unit 100 in the optical modulator illustrated in FIG. 12 includes a lithium niobate (LN: LiNbO₃) substrate 101 that is an LN crystal, and diffused optical waveguides 102 that are formed on a surface of the LN substrate 101. Further, the DC modulation unit 100 includes a buffer layer 103 that covers the diffused optical waveguides 102 on the LN substrate 101, and an electrode 104 that is laminated on the buffer layer 103. The electrode 104 includes a signal electrode 104A and a pair of ground electrodes 104B.

The diffused optical waveguides 102 are arranged at positions that do not overlap with the signal electrode 104A and the pair of ground electrodes 104B. Composition and a film thickness of the buffer layer 103 are determined such that a resistance value is reduced to prevent DC drift (a temporal change of emission light caused by applied bias voltage). Meanwhile, positive and negative mobile charges are present in the LN substrate 101.

However, optical confinement in the diffused optical waveguides 102 is low, so that electric field application efficiency is reduced and driving voltage is increased. To cope with this, a thin-film optical waveguide, in which an optical waveguide using a thin film made of an LN crystal is formed at a position that does not overlap with the signal electrode, has been proposed. In the thin-film optical waveguide, it is possible to increase optical confinement as compared to the diffused optical waveguide in which a metal is diffused, so that it is possible to improve the electric field application efficiency and reduce the driving voltage.

FIG. 13 is a schematic cross-sectional view illustrating an example of a DC modulation unit 200 of the conventional optical modulator. The DC modulation unit 200 illustrated in FIG. 13 includes a support substrate 201 that is made of silicon (Si) or the like, and an intermediate layer 202 that is laminated on the support substrate 201. Further, the DC modulation unit 200 includes a thin-film LN substrate 203 that is laminated on the intermediate layer 202, and a buffer layer 204 that is made of SiO₂ and laminated on the thin-film LN substrate 203.

The thin-film LN substrate 203 serves as convex-shaped thin-film optical waveguides 206 that protrude upward. Each of the thin-film optical waveguides 206 is a rib waveguide that includes a rib 206A and slabs 206B that are formed on both sides of the rib 206A. Further, the ribs 206A and the slabs 206B are covered by the buffer layer 204, and a signal electrode 205A (205) and a pair of ground electrodes 205B (205) having a coplanar waveguide (CPW) structure are arranged on a surface of the buffer layer 204. In other words, the signal electrode 205A and the pair of ground electrodes 205B sandwiching the signal electrode 205A are arranged on the buffer layer 204. Meanwhile, the buffer layer 204 is able to prevent light that propagates through the thin-film optical waveguides 206 from being absorbed by the signal electrode 205A and the ground electrodes 205B.

The convex-shaped thin-film optical waveguides 206 are formed on the thin-film LN substrate 203 at positions between the signal electrode 205A and each of the ground electrodes 205B. Further, stepped portions 204A that cover the entire convex-shaped thin-film optical waveguides 206 are arranged on the buffer layer 204 at the positions between the signal electrode 205A and each of the ground electrodes 205B.

With use of the thin-film optical waveguides 206 as described above, by applying bias voltage to the signal electrode 205A to generate electric fields and changing refractive indices of the thin-film optical waveguides 206, it is possible to modulate light that propagates through the thin-film optical waveguides 206.

Patent Literature 1: Japanese Laid-open Patent Publication No. 2013-007909

Patent Document: U.S. Unexamined Patent Application Publication No. 2014/0270617

However, in the optical modulator, if a film thickness of the LN substrate is reduced, density of mobile charges in the LN crystal increases and the mobile charges are likely to affect the thin-film optical waveguides 206, so that the electric fields in the thin-film optical waveguides 206 become unstable. As a result, the electric fields in the thin-film optical waveguides 206 become unstable and it becomes difficult to control the optical device.

### SUMMARY

According to an aspect of an embodiment, an optical device includes a rib optical waveguide, a buffer layer, an electrode and sub electrodes. The rib optical waveguide is a thin-film lithium niobate (LN) crystal formed of a thin-film LN substrate. The buffer layer is laminated on the optical waveguide. The electrode is laminated on the buffer layer. The sub electrodes are arranged parallel to the electrode on the buffer layer, and attract a charge in the optical waveguide in accordance with electrification.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a first embodiment;

FIG. 2 is a schematic plan view illustrating an example of a configuration of an optical modulator according to the first embodiment;

FIG. 3 is a schematic cross-sectional view taken along a line A-A, which illustrates an example of a second DC modulation unit of the optical modulator according to the first embodiment;

FIG. 4 is a schematic plan view illustrating an example of a configuration of an optical modulator according to a second embodiment;

FIG. 5 is a schematic cross-sectional view taken along a line B-B, which illustrates an example of a second DC modulation unit of the optical modulator according to the second embodiment;

FIG. 6 is a schematic plan view illustrating an example of a configuration of an optical modulator according to a third embodiment;

FIG. 7 is a schematic cross-sectional view taken along a line B-B, which illustrates an example of a second DC modulation unit of the optical modulator according to the third embodiment;

FIG. 8 is a schematic cross-sectional view taken along a line B-B, which illustrates an example of a second DC modulation unit of an optical modulator according to a fourth embodiment;

FIG. 9 is a schematic cross-sectional view taken along a line B-B, which illustrates an example of a second DC modulation unit of an optical modulator according to a fifth embodiment;

FIG. 10 is a schematic plan view illustrating an example of a configuration of an optical modulator according to a sixth embodiment;

FIG. 11 is a schematic cross-sectional view taken along a line C-C, which illustrates an example of an RF modulation unit of the optical modulator according to the sixth embodiment;

FIG. 12 is a schematic cross-sectional view illustrating an example of a DC modulation unit of a conventional optical modulator; and

FIG. 13 is a schematic cross-sectional view illustrating an example of a DC modulation unit of the conventional optical modulator.

### DESCRIPTION OF EMBODIMENTS

Preferred embodiments of the present invention will be explained with reference to accompanying drawings. The present invention is not limited by the embodiments below.

### [a] First Embodiment

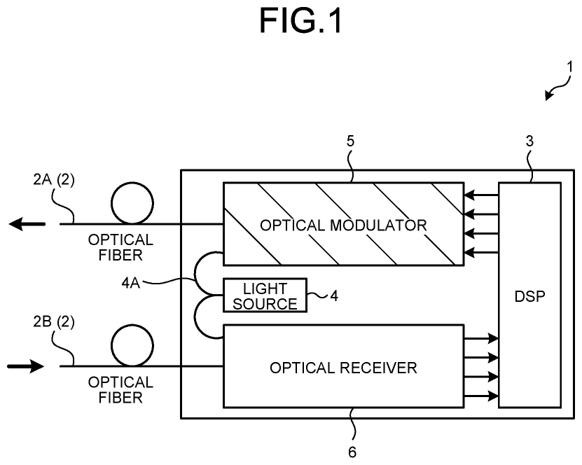

FIG. 1 is a block diagram illustrating an example of a configuration of an optical communication apparatus 1 according to a first embodiment. The optical communication apparatus 1 illustrated in FIG. 1 is connected to an optical fiber 2A (2) at an output side and an optical fiber 2B (2) at an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs processing, such as encoding, on transmission data, generates an electrical signal including the transmission data, and outputs the generated electrical signal to the optical modulator 5, for example. Further, the DSP 3 acquires an electrical signal including reception data from the optical receiver 6, performs processing, such as decoding, on the acquired electrical signal, and obtains reception data.

The light source 4 includes, for example, a laser diode or the like, generates light at a predetermined wavelength, and supplies the light to the optical modulator 5 and the optical receiver 6. The optical modulator 5 is an optical device that modulates the light supplied from the light source 4 by using the electrical signal output from the DSP 3, and outputs the obtained optical transmission signal to the optical fiber 2A. The optical modulator 5 is an optical device, such as a lithium niobate (LN: LiNbO₃) optical modulator, that includes LN optical waveguides and a modulation unit, for example. The LN optical waveguides are formed by a substrate made of an LN crystal. The optical modulator 5, when the light supplied from the light source 4 propagates through the LN optical waveguides, modulates the light by the electrical signal that is input to the modulation unit, and generates an optical transmission signal.

The optical receiver 6 receives an optical signal from the optical fiber 2B and demodulates the received optical signal by using the light supplied from the light source 4. Then, the optical receiver 6 converts the demodulated received optical signal into an electrical signal, and outputs the converted electrical signal to the DSP 3.

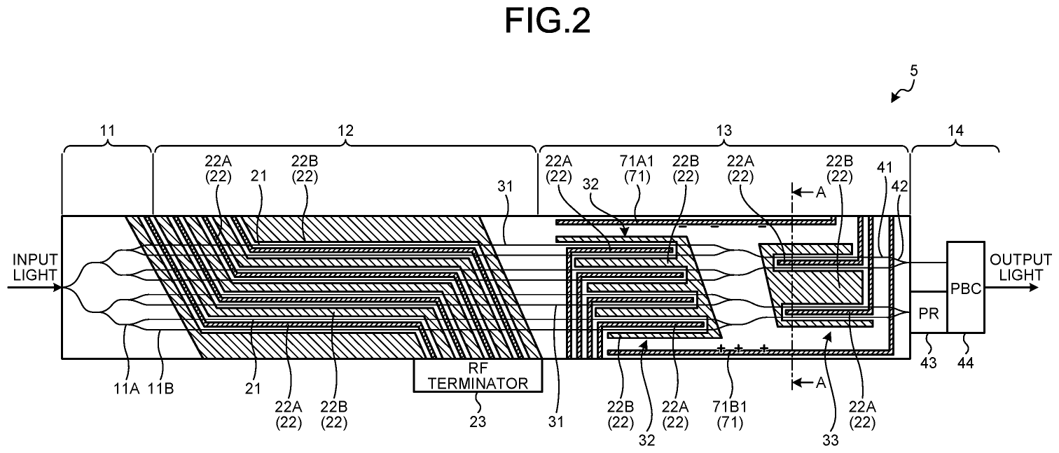

FIG. 2 is a schematic plan view illustrating an example of a configuration of the optical modulator 5 according to the first embodiment. The optical modulator 5 illustrated in FIG. 2 is connected to an optical fiber 4A from the light source 4 at an input side and is connected to the optical fiber 2A for outputting a transmission signal at an output side. The optical modulator 5 includes a first optical input unit 11, a radio frequency (RF) modulation unit 12, a direct current (DC) modulation unit 13, and a first optical output unit 14. The first optical input unit 11 includes a first optical waveguide 11A and first waveguide bonding units 11B. The first optical waveguide 11A is an LN optical waveguide that includes a single optical waveguide that is connected to the optical fiber 4A, two optical waveguides that are branched from the single optical waveguide, four optical waveguides that are branched from the two optical waveguides, and eight optical waveguides that are branched from the four optical waveguides. The first waveguide bonding units 11B bond the eight optical waveguides in the first optical waveguide 11A and eight LN optical waveguides in the LN optical waveguides 21.

The RF modulation unit 12 includes the LN optical waveguides 21, electrodes 22, and an RF terminator 23. The RF modulation unit 12, when light supplied from the first optical waveguide 11A propagates through the LN optical waveguides 21, modulates the light by using electric fields that are applied from signal electrodes 22A of the electrodes 22. The LN optical waveguides 21 are, for example, rib optical waveguides that are formed by using a thin-film LN substrate 53, are repeatedly branched from the input side, and are formed of the eight LN optical waveguides that are parallel to one another. The light that propagates through and modulated in the LN optical waveguides 21 is output to first DC modulation units 32 in the DC modulation unit 13. The thin-film LN substrate 53 has spontaneous polarization in a Z direction of a crystal axis of the LN crystal, and therefore has an internal electric field in the thin-film LN crystal.

The signal electrodes 22A in the electrodes 22 are arranged at positions that do not overlap with the LN optical waveguides 21, and apply electric fields to the LN optical waveguides 21 in accordance with an electric signal that is output from the DSP 3. Terminal ends of the signal electrodes 22A in the electrodes 22 are connected to the RF terminator 23. The RF terminator 23 is connected to the terminal ends of the signal electrodes 22A, and prevents unnecessary reflection of signals that are transmitted by the signal electrodes 22A.

The DC modulation unit 13 includes LN optical waveguides 31 that are bonded to the LN optical waveguides 21 of the RF modulation unit 12, the first DC modulation units 32, second DC modulation units 33, and sub electrodes 71. The first DC modulation units 32 are formed of four child-side Mach-Zehnder (MZ) interferometers. The second DC modulation units 33 are formed of two parent-side MZ interferometers. The first DC modulation units 32 include the LN optical waveguides 31 and the electrodes 22. The LN optical waveguides 31 are, for example, rib optical waveguides that are formed by using the thin-film LN substrate 53. Meanwhile, a film thickness of the thin-film LN substrate 53 is reduced, so that the thin-film LN substrate 53 is in a state in which density of mobile charges remaining in the thin-film LN substrate 53 is high. The thin-film LN substrate 53 has spontaneous polarization in the Z direction of the crystal axis of the LN crystal, and therefore has an internal electric field in the thin-film LN crystal.

The sub electrodes 71 are arranged parallel to each other so as to sandwich the plurality of LN optical waveguides 31, and attract the mobile charges remaining in the thin-film LN substrate 53 to the vicinities of the sub electrodes 71. As a result, the mobile charges are removed from ribs 60A in thin-film optical waveguides 60 of the thin-film LN substrate 53.

The LN optical waveguides 31 include eight LN optical waveguides, and four LN optical waveguides that merge with two LN optical waveguides among the eight LN optical waveguides. The first DC modulation unit 32 is arranged for each two LN optical waveguides among the eight LN optical waveguides 31. The first DC modulation units 32 apply bias voltage to the signal electrodes 22A on the LN optical waveguides 31 to adjust bias voltage such that ON/OFF of an electrical signal corresponds to ON/OFF of an optical signal, and output I signals that are in-phase components or Q signals that are quadrature components. The second DC modulation unit 33 is arranged for each two LN optical waveguides among the four LN optical waveguides in the LN optical waveguides 31. The second DC modulation units 33 apply bias voltage to the signal electrodes 22A on the LN optical waveguides 31 to adjust bias voltage such that ON/OFF of an electrical signal corresponds to ON/OFF of an optical signal, and output I signals or Q signals.

The sub electrodes 71 are formed of a first sub electrode 71A and a second sub electrode 71B. The first sub electrode 71A is a positive-side charge electrode that attracts negative mobile charges remaining in the thin-film LN substrate 53 to the vicinity of the first sub electrode 71A. As a result, the negative mobile charges are removed from the ribs 60A in the thin-film optical waveguides 60 of the thin-film LN substrate 53. The second sub electrode 71B is a negative-side charge electrode that attracts positive mobile charges remaining in the thin-film LN substrate 53 to the vicinity of the second sub electrode 71B. As a result, the positive mobile charges are removed from the ribs 60A in the thin-film optical waveguides 60 of the thin-film LN substrate 53.

The first optical output unit 14 includes second waveguide bonding units 41, second optical waveguides 42, a polarization rotator (PR) 43, and a polarization beam combiner (PBC) 44. The second waveguide bonding units 41 bond the LN optical waveguides 31 in the DC modulation unit 13 and the second optical waveguides 42. The second optical waveguides 42 are LN optical waveguides that are formed of four optical waveguides that are connected to the second waveguide bonding units 41, and two optical waveguides that merge with two optical waveguides among the four optical waveguides.

The PR 43 rotates the I signal or the Q signal that is input from one of the second DC modulation units 33 by 90 degrees, and obtains a vertically-polarized optical signal that is rotated by 90 degrees. Then, the PR 43 inputs the vertically-polarized optical signal to the PBC 44. The PBC 44 couples the vertically-polarized optical signal input from the PR 43 and a horizontally-polarized optical signal that is input from the other one of the second DC modulation units 33, and outputs a dual-polarized signal.

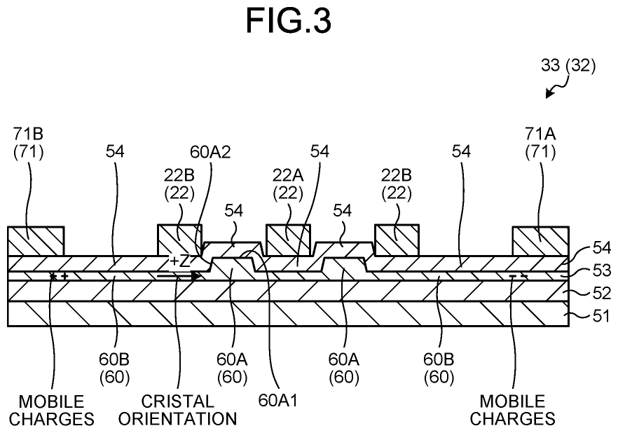

A configuration of the optical modulator 5 according to the first embodiment will be described in detail below. FIG. 3 is a schematic cross-sectional view taken along a line A-A, which illustrates an example of the second DC modulation unit 33 of the optical modulator 5 according to the first embodiment. Meanwhile, for convenience of explanation, a single MZ interferometer is illustrated in the schematic cross-sectional view in FIG. 3, although the case has been illustrated in FIG. 2 in which the second DC modulation units 33 are formed of the two MZ interferometers. Further, as for the first DC modulation units 32, although the case has been illustrated in which the first DC modulation units 32 are formed of the four MZ interferometers, each of the MZ interferometers has the same configuration as the second DC modulation units 33, and therefore, the same components are denoted by the same reference symbols, and explanation of the same configurations and operation will be omitted. The second DC modulation unit 33 illustrated in FIG. 3 includes a support substrate 51, and an intermediate layer 52 that is laminated on the support substrate 51. Further, the second DC modulation unit 33 includes the thin-film LN substrate 53 that is a thin-film LN crystal laminated on the intermediate layer 52, a buffer layer 54 that is laminated on the thin-film LN substrate 53, the electrode 22, and the sub electrodes 71. The electrode 22 includes the signal electrode 22A and a pair of ground electrodes 22B.

The first sub electrode 71A in the sub electrodes 71 is arranged on the buffer layer 54, and attracts the negative mobile charges remaining in the thin-film LN substrate 53 to the vicinity of the first sub electrode 71A. The second sub electrode 71B in the sub electrodes 71 is arranged on the buffer layer 54, and attracts the positive mobile charges remaining in the thin-film LN substrate 53 to the vicinity of the second sub electrode 71B.

The support substrate 51 is a substrate that is made of, for example, Si, LN, or the like. The intermediate layer 52 is a layer that is made of a transparent material, such as SiO₂ or TiO₂, with a lower refractive index than LN. Similarly, the buffer layer 54 is a layer that is made of a transparent material, such as SiO₂ or TiO₂, with a lower refractive index than LN.

The thin-film LN substrate 53 serves as the convex-shaped thin-film optical waveguides 60 that protrude upward. The thin-film optical waveguides 60 are the LN optical waveguides 31 of the second DC modulation unit 33. Each of the thin-film optical waveguides 60 is a rib optical waveguide that includes the rib 60A and slabs 60B that are formed on both sides of the rib 60A. Each of the ribs 60A includes an upper surface 60A1 of the rib 60A and a side wall surface 60A2 of the rib 60A. Further, the thin-film optical waveguides 60 are covered by the buffer layer 54. The buffer layer 54 is arranged to prevent light that propagates through the thin-film optical waveguides 60 from being absorbed by the electrode 22.

The buffer layer 54 covers the upper surfaces 60A1 of the ribs 60A of the thin-film optical waveguides 60, and covers the slabs 60B of the thin-film optical waveguides 60. The signal electrode 22A and the pair of ground electrodes 22B are arranged on the buffer layer 54.

The ribs 60A in the thin-film optical waveguides 60 serve as the thin-film optical waveguides 60 located between the signal electrode 22A and each of the ground electrodes 22B. The slabs 60B in the thin-film optical waveguides 60 serve as the thin-film optical waveguides 60 located at the signal electrode 22A and the ground electrodes 22B.

The thin-film optical waveguides 60 of the thin-film LN substrate 53 with thicknesses of 0.5 to 3 micrometers (μm) are sandwiched between the intermediate layer 52 and the buffer layer 54. Widths of the ribs 60A that serve as the thin-film optical waveguides 60 are, for example, about 1 to 8 μm.

The signal electrode 22A is an electrode that is made of a metal material, such as gold or copper, has a width of 2 to 10 μm, and has a thickness of 1 to 20 μm, for example. The ground electrodes 22B are electrodes that are made of a metal material, such as gold or copper, and have thicknesses of 1 μm or more, for example. If bias voltage corresponding to the electric signal that is output from the DSP 3 is applied to the signal electrode 22A, electric fields in directions from the signal electrode 22A to the ground electrodes 22B are generated, and the electric fields are applied to the thin-film optical waveguides 60. As a result, refractive indices of the thin-film optical waveguides 60 are changed in accordance with the application of the electric fields to the thin-film optical waveguides 60, and it becomes possible to modulate light that propagates through the thin-film optical waveguides 60.

The first sub electrode 71A is an electrode that is made of a metal material, such as gold or copper, has a width of 2 to 10 μm, and has a thickness of 1 to 20 μm, for example. The second sub electrode 71B is also an electrode that is made of a metal material, such as gold or copper, has a width of 2 to 10 μm, and has a thickness of 1 to 20 μm, for example.

In the second DC modulation units 33, for example, the first sub electrode 71A and the second sub electrode 71B are electrified before shipment from a factory before operation, and mobile charges remaining in the thin-film LN crystal in the thin-film LN substrate 53 are attracted to the vicinities of the first sub electrode 71A and the second sub electrode 71B. The mobile charges remaining in the ribs 60A are removed and the mobile charges are accumulated in the vicinities of the first sub electrode 71A and the second sub electrode 71B, so that it is possible to stabilize the electric fields in the thin-film optical waveguides 60. As a result, it is possible to stabilize DC characteristics and prevent occurrence of DC drift. In addition, it is possible to increase lifetimes of the second DC modulation units 33.

The first sub electrode 71A and the second sub electrode 71B are arranged in the Z-axis direction of the LN crystal with respect to the electrodes 22. Therefore, if orientation of the electric fields at the time of electrification is set to the same as orientation of the internal electric field, the removed mobile charges are accumulated in the vicinities of the first sub electrode 71A and the second sub electrode 71B with the aid of the internal electric field of the LN crystal even after completion of the electrification, so that it is possible to reduce an influence on the thin-film optical waveguides 60.

In the second DC modulation units 33 according to the first embodiment, by electrifying the first sub electrode 71A and the second sub electrode 71B, the mobile charges remaining in the thin-film LN crystal of the thin-film LN substrate 53 are attracted to the vicinities of the first sub electrode 71A and the second sub electrode 71B. The mobile charges remaining in the ribs 60A are removed and the mobile charges are accumulated in the vicinities of the first sub electrode 71A and the second sub electrode 71B, so that it is possible to stabilize the electric fields in the thin-film optical waveguides 60. As a result, it is possible to stabilize the DC characteristics and prevent occurrence of the DC drift. In addition, it is possible to increase the lifetimes of the second DC modulation units 33.

The second DC modulation units 33 attract the negative mobile charges remaining in the thin-film LN crystal to the vicinity of the first sub electrode 71A, and attract the positive mobile charges remaining in the thin-film LN crystal to the vicinity of the second sub electrode 71B. As a result, the mobile charges remaining in the ribs 60A are removed and the mobile charges are accumulated in the first sub electrode 71A and the second sub electrode 71B, so that it is possible to stabilize the electric fields in the thin-film optical waveguides 60.

In the first DC modulation units 32, by electrifying the first sub electrode 71A and the second sub electrode 71B, the mobile charges remaining in the thin-film LN crystal in the thin-film LN substrate 53 are attracted to the vicinities of the first sub electrode 71A and the second sub electrode 71B. The mobile charges remaining in the ribs 60A are removed and the mobile charges are accumulated in the vicinities of the first sub electrode 71A and the second sub electrode 71B, so that it is possible to stabilize the electric fields in the thin-film optical waveguides 60. As a result, it is possible to stabilize the DC characteristics and prevent occurrence of the DC drift. In addition, it is possible to increase lifetimes of the first DC modulation units 32.

The first DC modulation units 32 attract the negative mobile charges remaining in the thin-film LN crystal to the vicinity of the first sub electrode 71A, and attract the positive mobile charges remaining in the thin-film LN crystal to the vicinity of the second sub electrode 71B. As a result, the mobile charges remaining in the ribs 60A are removed and the mobile charges are accumulated in the first sub electrode 71A and the second sub electrode 71B, so that it is possible to stabilize the electric fields in the thin-film optical waveguides 60.

Meanwhile, in the first embodiment, the case has been described in which the technology is applied to the DC modulation unit 13, but the technology is also applicable to the RF modulation unit 12.

The case has been illustrated in which the second DC modulation units 33 of the first embodiment include the first sub electrode 71A for removing the negative mobile charges and the second sub electrode 71B for removing the positive mobile charges. However, each of the sub electrodes 71 may be configured as a pair of sub electrodes, and this embodiment will be described below as a second embodiment.

### [b] Second Embodiment

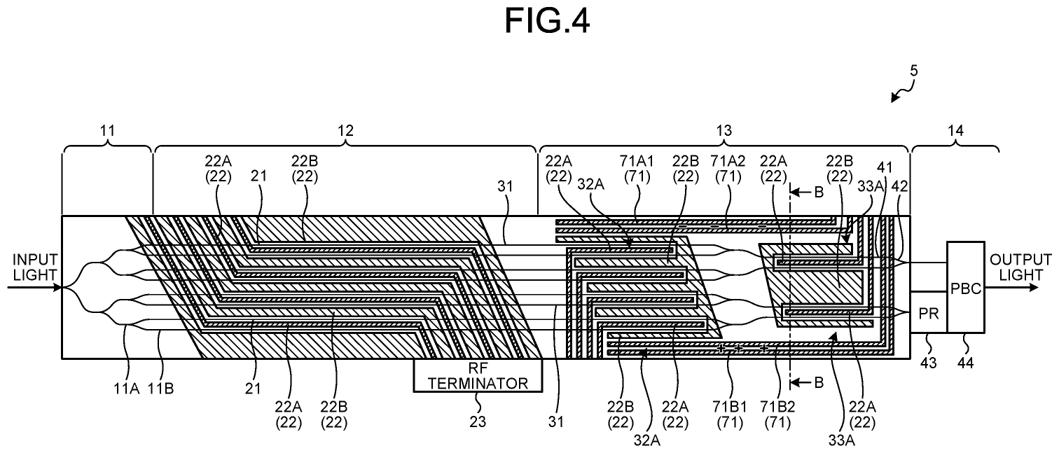

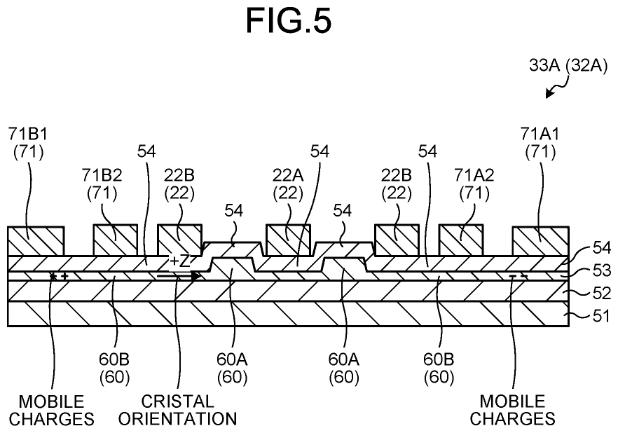

FIG. 4 is a schematic plan view illustrating an example of a configuration of the optical modulator 5 according to the second embodiment, and FIG. 5 is a schematic cross-sectional view taken along a line B-B, which illustrates an example of a second DC modulation unit 33A of the optical modulator 5 according to the second embodiment. Meanwhile, for convenience of explanation, a single MZ interferometer is illustrated in the schematic cross-sectional view in FIG. 5, although the case is illustrated in FIG. 4 in which the second DC modulation units 33A are formed of two MZ interferometers. Further, as for first DC modulation units 32A, although a case is illustrated in which the first DC modulation units 32A are formed of four MZ interferometers, each of the MZ interferometers has the same configuration as the second DC modulation units 33A, and therefore, the same components are denoted by the same reference symbols, and explanation of the same configurations and operation will be omitted. The second DC modulation units 33A illustrated in FIG. 4 are different from the second DC modulation units 33 illustrated in FIG. 3 in that a pair of sub electrodes is arranged instead of the first sub electrode 71A, and a pair of sub electrodes is arranged instead of the second sub electrode 71B.

The second DC modulation unit 33A includes a first positive-side sub electrode 71A1 and a first negative-side sub electrode 71A2 as a pair of sub electrodes, instead of the first sub electrode 71A. The first positive-side sub electrode 71A1 attracts the negative mobile charges in the thin-film LN crystal in the thin-film LN substrate 53 to the vicinity of the first positive-side sub electrode 71A1 in accordance with electrification. Meanwhile, the electrification timing is, for example, before shipment of the optical modulator 5 from a factory. As a result, the negative mobile charges are removed from the ribs 60A in the thin-film optical waveguides 60 of the thin-film LN substrate 53. The first negative-side sub electrode 71A2 attracts the positive mobile charges in the thin-film LN crystal in the thin-film LN substrate 53 to the vicinity of the first negative-side sub electrode 71A2 in accordance with electrification. As a result, the positive mobile charges are removed from the ribs 60A in the thin-film optical waveguides 60 of the thin-film LN substrate 53.

The second DC modulation unit 33A includes a second positive-side sub electrode 71B2 and a second negative-side sub electrode 71B1 as a pair of sub electrodes, instead of the second sub electrode 71B. The second positive-side sub electrode 71B2 attracts the negative mobile charges in the thin-film LN crystal in the thin-film LN substrate 53 to the vicinity of the second positive-side sub electrode 71B2 in accordance with electrification. As a result, the negative mobile charges are removed from the ribs 60A in the thin-film optical waveguides 60 of the thin-film LN substrate 53. The second negative-side sub electrode 71B1 attracts the positive mobile charges in the thin-film LN crystal in the thin-film LN substrate 53 to the vicinity of the second negative-side sub electrode 71B1 in accordance with electrification. As a result, the positive mobile charges are removed from the ribs 60A in the thin-film optical waveguides 60 of the thin-film LN substrate 53.

In the second DC modulation units 33A according to the second embodiment, the first positive-side sub electrode 71A1 is used to attract the negative mobile charges in the thin-film LN crystal in the thin-film LN substrate 53 to the vicinity of the first positive-side sub electrode 71A1. Further, in the second DC modulation units 33A, the first negative-side sub electrode 71A2 is used to attract the positive mobile charges in the thin-film LN crystal in the thin-film LN substrate 53 to the vicinity of the first negative-side sub electrode 71A2. Furthermore, in the second DC modulation units 33A, the second positive-side sub electrode 71B2 is used to attract the negative mobile charges in the thin-film LN crystal in the thin-film LN substrate 53 to the vicinity of the second positive-side sub electrode 71B2. Moreover, in the second DC modulation units 33A, the second negative-side sub electrode 71B1 is used to attract the positive mobile charges in the thin-film LN crystal in the thin-film LN substrate 53 to the vicinity of the second negative-side sub electrode 71B1. As a result, the mobile charges remaining in the ribs 60A are removed and the mobile charges are accumulated in the vicinities of the first positive-side sub electrode 71A1, the first negative-side sub electrode 71A2, the second positive-side sub electrode 71B2, and the second negative-side sub electrode 71B1, so that it is possible to stabilize the electric fields in the thin-film optical waveguides 60. With the stabilized electric fields in the thin-film optical waveguides 60, the DC characteristics are stabilized, so that it is possible to prevent occurrence of the DC drift. It is possible to increase lifetimes of the second DC modulation units 33A.

In the first DC modulation units 32A, the first positive-side sub electrode 71A1 is used to attract the negative mobile charges in the thin-film LN crystal in the thin-film LN substrate 53 to the vicinity of the first positive-side sub electrode 71A1. Further, in the first DC modulation units 32A, the first negative-side sub electrode 71A2 is used to attract the positive mobile charges in the thin-film LN crystal in the thin-film LN substrate 53 to the vicinity of the first negative-side sub electrode 71A2. Furthermore, in the first DC modulation units 32A, the second positive-side sub electrode 71B2 is used to attract the negative mobile charges in the thin-film LN crystal in the thin-film LN substrate 53 to the vicinity of the second positive-side sub electrode 71B2. Moreover, in the first DC modulation units 32A, the second negative-side sub electrode 71B1 is used to attract the positive mobile charges in the thin-film LN crystal in the thin-film LN substrate 53 to the vicinity of the second negative-side sub electrode 71B1. As a result, the mobile charges remaining in the ribs 60A are removed and the mobile charges are accumulated in the vicinities of the first positive-side sub electrode 71A1, the first negative-side sub electrode 71A2, the second positive-side sub electrode 71B2, and the second negative-side sub electrode 71B1, so that it is possible to stabilize the electric fields in the thin-film optical waveguides 60. With the stabilized electric fields in the thin-film optical waveguides 60, the DC characteristics are stabilized, so that it is possible to prevent occurrence of the DC drift. It is possible to increase lifetimes of the first DC modulation units 32A.

In the optical modulator 5, when the plurality of MZ interferometers are arranged parallel to one another, the first positive-side sub electrode 71A1, the first negative-side sub electrode 71A2, the second positive-side sub electrode 71B2, and the second negative-side sub electrode 71B1 are arranged on outer sides of the plurality of MZ interferometers. As a result, the optical modulator 5 is able to stabilize the DC drift of all of the MZ interferometers.

Meanwhile, in the second embodiment, the case has been described in which the technology is applied to the DC modulation unit 13, but the technology is also applicable to the RF modulation unit 12.

In the second DC modulation units 33A according to the second embodiment, for example, the case has been illustrated in which bias voltage applied to the first positive-side sub electrode 71A1 and bias voltage applied to the signal electrodes 22A in a separate manner. However, it may be possible to apply common bias voltage to the first positive-side sub electrode 71A1, the second positive-side sub electrode 71B2, and the signal electrodes 22A, and this embodiment will be described below as a third embodiment.

### [c] Third Embodiment

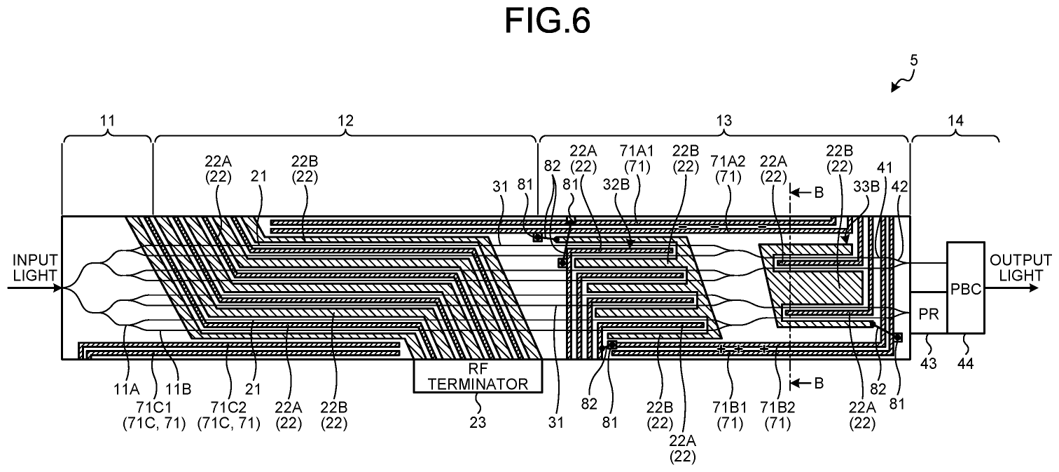

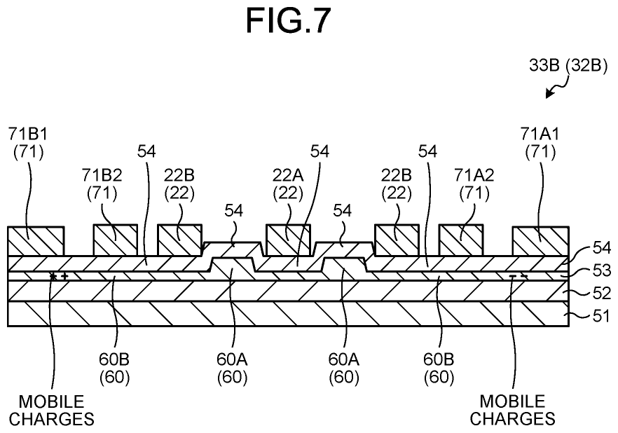

FIG. 6 is a schematic plan view illustrating an example of a configuration of the optical modulator 5 according to the third embodiment, and FIG. 7 is a schematic cross-sectional view illustrating an example of a second DC modulation unit 33B of the optical modulator 5 according to the third embodiment. Meanwhile, the same components as those of the optical modulator 5 according to the second embodiment are denoted by the same reference symbols, and explanation of the same configurations and operation will be omitted. The second DC modulation units 33B illustrated in FIG. 6 are different from the second DC modulation units 33A illustrated in FIG. 5 in that common bias voltage is applied to the first positive-side sub electrode 71A1, the second positive-side sub electrode 71B2, and the signal electrodes 22A.

An electrode pad 81 in the first positive-side sub electrode 71A1 is electrically connected to the electrode pad 81 in the signal electrode 22A by wire bonding 82. The electrode pad 81 in the first negative-side sub electrode 71A2 is electrically connected to the electrode pad 81 in the ground electrode 22B by the wire bonding 82.

The electrode pad 81 in the second positive-side sub electrode 71B2 is electrically connected to the electrode pad 81 in the signal electrode 22A by the wire bonding 82. The electrode pad 81 in the second negative-side sub electrode 71B1 is electrically connected to the electrode pad 81 in the ground electrode 22B by the wire bonding 82.

The first positive-side sub electrode 71A1 and the second positive-side sub electrode 71B2 are electrically connected to the signal electrodes 22A, so that bias voltage applied to the signal electrodes 22A is common to bias voltage applied to the first positive-side sub electrode 71A1 and the second positive-side sub electrode 71B2.

The second DC modulation units 33B apply bias voltage to the first positive-side sub electrode 71A1 and the second positive-side sub electrode 71B2 in accordance with electrification to the signal electrodes 22A. Further, the negative mobile charges in the thin-film LN crystal in the thin-film LN substrate 53 are attracted to the first positive-side sub electrode 71A1 and the second positive-side sub electrode 71B2. As a result, even during operation of the optical modulator 5, the mobile charges remaining in the ribs 60A are removed and the mobile charges are accumulated in the vicinities of the first positive-side sub electrode 71A1 and the second positive-side sub electrode 71B2, so that it is possible to stabilize the electric fields in the thin-film optical waveguides 60. With the stabilized electric fields in the thin-film optical waveguides 60, the DC characteristics are stabilized, so that it is possible to prevent occurrence of the DC drift.

The second DC modulation units 33B apply bias voltage to the first negative-side sub electrode 71A2 and the second negative-side sub electrode 71B1 in accordance with electrification to the ground electrodes 22B. Further, the positive mobile charges in the thin-film LN crystal in the thin-film LN substrate 53 are attracted to the vicinities of the first negative-side sub electrode 71A2 and the second negative-side sub electrode 71B1. As a result, even during operation of the optical modulator 5, the mobile charges remaining in the ribs 60A are removed and the mobile charges are accumulated in the first negative-side sub electrode 71A2 and the second negative-side sub electrode 71B1, so that it is possible to stabilize the electric fields in the thin-film optical waveguides 60. With the stabilized electric fields in the thin-film optical waveguides 60, the DC characteristics are stabilized, so that it is possible to prevent occurrence of the DC drift.

The electrode pad 81 in the first positive-side sub electrode 71A1 is electrically connected to the electrode pad 81 in the signal electrode 22A by the wire bonding 82. The electrode pad 81 in the second positive-side sub electrode 71B2 is electrically connected to the electrode pad 81 in the signal electrode 22A by the wire bonding 82. As a result, it is possible to use common bias voltage as bias voltage applied to the signal electrodes 22A, the first positive-side sub electrode 71A1, and the second positive-side sub electrode 71B2, and improve operation performance of the wire bonding.

The electrode pad 81 in the first negative-side sub electrode 71A2 is electrically connected to the electrode pad 81 in the ground electrode 22B by the wire bonding 82. The electrode pad 81 in the second negative-side sub electrode 71B1 is electrically connected to the electrode pad 81 in the ground electrode 22B by the wire bonding 82. As a result, it is possible to use common bias voltage as bias voltage applied to the ground electrodes 22B, the first negative-side sub electrode 71A2, and the second negative-side sub electrode 71B1, and improve operation performance of the wire bonding.

First DC modulation units 32B apply bias voltage to the first positive-side sub electrode 71A1 and the second positive-side sub electrode 71B2 in accordance with electrification to the signal electrodes 22A. Further, the negative mobile charges in the thin-film LN crystal in the thin-film LN substrate 53 are attracted to the vicinities of the first positive-side sub electrode 71A1 and the second positive-side sub electrode 71B2. The first DC modulation units 32B attract the positive mobile charges in the thin-film LN crystal in the thin-film LN substrate 53 to the vicinities of the first negative-side sub electrode 71A2 and the second negative-side sub electrode 71B1 in accordance with electrification to the signal electrodes 22A. As a result, even during operation of the optical modulator 5, the mobile charges remaining in the ribs 60A are accumulated in the vicinities of the first positive-side sub electrode 71A1, the first negative-side sub electrode 71A2, the second positive-side sub electrode 71B2, and the second negative-side sub electrode 71B1, so that it is possible to stabilize the electric fields in the thin-film optical waveguides 60. With the stabilized electric fields in the thin-film optical waveguides 60, the DC characteristics are stabilized, so that it is possible to prevent occurrence of the DC drift. In addition, it is possible to use common bias voltage as bias voltage applied to the signal electrodes 22A, the first positive-side sub electrode 71A1, and the second positive-side sub electrode 71B2, and improve operation performance of the wire bonding.

Meanwhile, in the third embodiment, the case has been described in which the technology is applied to the DC modulation unit 13, but the technology is also applicable to the RF modulation unit 12.

The case has been illustrated in which the sub electrodes 71 are arranged on the buffer layer 54 on the slabs 60B of the thin-film optical waveguides 60 of the second DC modulation units 33B according to the third embodiment. However, it may be possible to set thicknesses of portions of the thin-film optical waveguides 60 on which the sub electrodes 71 are arranged to the same thickness as the ribs 60A, and this embodiment will be described below as a fourth embodiment.

### [d] Fourth Embodiment

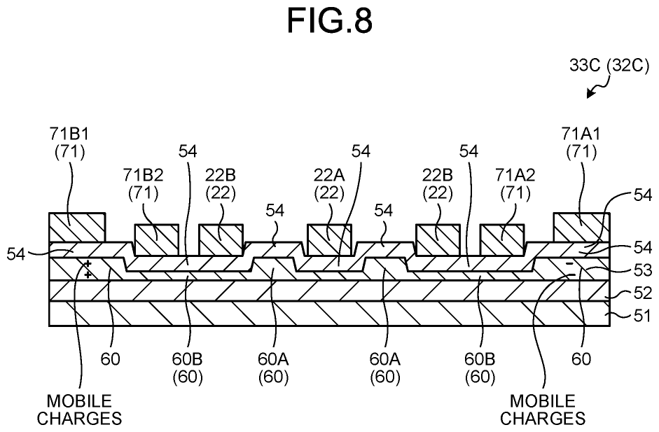

FIG. 8 is a schematic cross-sectional view taken along a line B-B, which illustrates an example of a second DC modulation unit 33C of the optical modulator 5 according to the fourth embodiment. Meanwhile, the same components as those of the optical modulator 5 according to the third embodiment are denoted by the same reference symbols, and explanation of the same configurations and operation will be omitted. The second DC modulation unit 33C illustrated in FIG. 8 is different from the second DC modulation units 33B illustrated in FIG. 6 in that a thickness of the thin-film LN substrate 53 below portions on which the first positive-side sub electrode 71A1 and the second negative-side sub electrode 71B1 are arranged is set to the same thickness as the ribs 60A. Further, the thickness of the thin-film LN substrate 53 below portions on which the first negative-side sub electrode 71A2 and the second positive-side sub electrode 71B2 is arranged are set to the same thickness as the slabs 60B.

In the second DC modulation units 33C, the thickness of the thin-film LN substrate 53 below the portions on which the first positive-side sub electrode 71A1 and the second negative-side sub electrode 71B1 are arranged is set to the same thickness as the ribs 60A. As a result, capacities of the first positive-side sub electrode 71A1 and the second negative-side sub electrode 71B1 are increased, and it is possible to prevent re-diffusion of the mobile charges.

In first DC modulation units 32C, the thickness of the thin-film LN substrate 53 below the portions on which the first positive-side sub electrode 71A1 and the second negative-side sub electrode 71B1 are arranged is set to the same thickness as the ribs 60A. As a result, the capacities of the first positive-side sub electrode 71A1 and the second negative-side sub electrode 71B1 are increased, and it is possible to prevent re-diffusion of the mobile charges.

Meanwhile, in the fourth embodiment, the case has been described in which the technology is applied to the DC modulation unit 13, but the technology is also applicable to the RF modulation unit 12.

The sub electrodes 71 are electrified until the mobile charges in the optical modulator 5 are attracted to the vicinities of the sub electrodes 71, but it is possible to reduce a time needed for the electrification by increasing temperature.

The case has been illustrated in which the arrangement portions of the first positive-side sub electrode 71A1 and the second negative-side sub electrode 71B1 in the second DC modulation units 33C according to the fourth embodiment are laminated on the buffer layer 54. However, behaviors of the sub electrodes 71 at the time of operation is more stabilized with an increase in a distance from the electrodes 22, but if the distance from the electrodes 22 is excessively increased, the electric fields in the thin-film optical waveguides 60 are reduced at the time of attracting the mobile charges. As a result, it becomes difficult to fully attract the mobile charges, and it takes a longer time to attract the mobile charges. To cope with this, it may be possible to form opening portions 54D in the buffer layer 54 in the arrangement portions of the first positive-side sub electrode 71A1 and the second negative-side sub electrode 71B1, and laminate the first positive-side sub electrode 71A1 and the second negative-side sub electrode 71B1 in the opening portions 54D. This embodiment will be described below as a fifth embodiment.

### [e] Fifth Embodiment

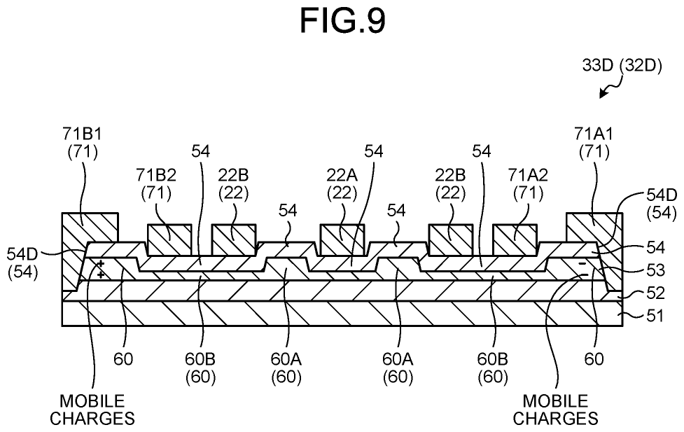

FIG. 9 is a schematic cross-sectional view taken along a line B-B, which illustrates an example of a second DC modulation unit 33D of the optical modulator 5 according to the fifth embodiment. Meanwhile, the same components as those of the optical modulator 5 according to the fourth embodiment are denoted by the same reference symbols, and explanation of the same configurations and operation will be omitted. The second DC modulation unit 33D illustrated in FIG. 9 is different from the second DC modulation unit 33C illustrated in FIG. 8 in that the opening portions 54D are formed in the buffer layer 54 in portions in which the first positive-side sub electrode 71A1 and the second negative-side sub electrode 71B1 are arranged, and a part of the first positive-side sub electrode 71A1 and a part of the second negative-side sub electrode 71B1 are laminated in the opening portions 54D.

The first positive-side sub electrode 71A1 and the second negative-side sub electrode 71B1 come into contact with the thin-film LN substrate 53 by the opening portions 54D. As a result, it is possible to efficiently attract the mobile charges while improving the electric field application efficiency.

In the second DC modulation units 33D according to the fifth embodiment, a part of the first positive-side sub electrode 71A1 and a part of the second negative-side sub electrode 71B1 come into contact with the thin-film LN substrate 53 by the opening portions 54D, so that it is possible to improve the electric field application efficiency and efficiently attract mobile charges. It is possible to reduce a time needed to attract the mobile charges.

In first DC modulation units 32D, a part of the first positive-side sub electrode 71A1 and a part of the second negative-side sub electrode 71B1 come into contact with the thin-film LN substrate 53 by the opening portions 54D, so that it is possible to improve the electric field application efficiency and efficiently attract the mobile charges. It is possible to reduce a time needed to attract the mobile charges.

Meanwhile, in the fifth embodiment, the case has been described in which the technology is applied to the DC modulation unit 13, but the technology is also applicable to the RF modulation unit 12.

The case has been illustrated in which the first sub electrode 71A and the second sub electrode 71B are arranged parallel to each other on the thin-film optical waveguides 60 of the first DC modulation units 32 and the second DC modulation units 33 of the optical modulator 5 according to the first embodiment. However, the technology is not limited to the first DC modulation units 32 and the second DC modulation units 33, but the technology may be applied to the RF modulation unit 12. This embodiment will be described below as a sixth embodiment.

### [f] Sixth Embodiment

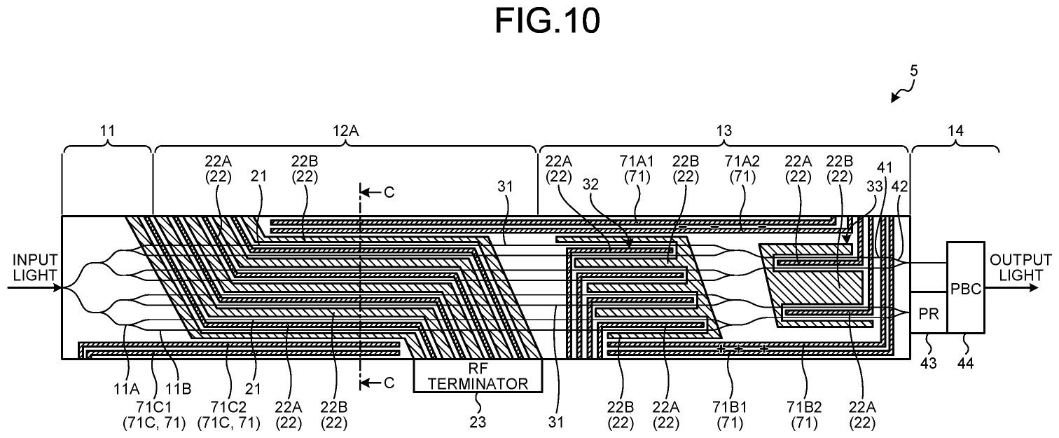

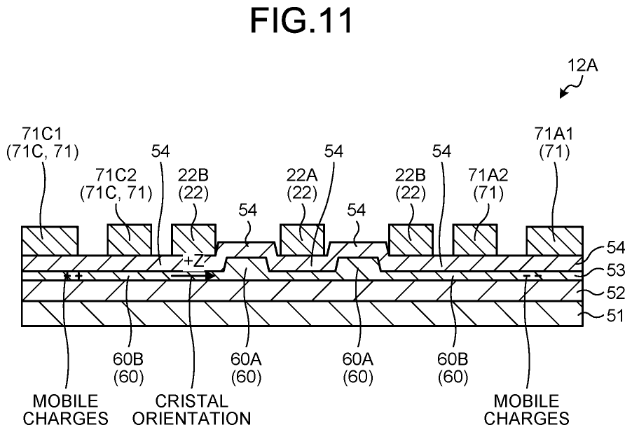

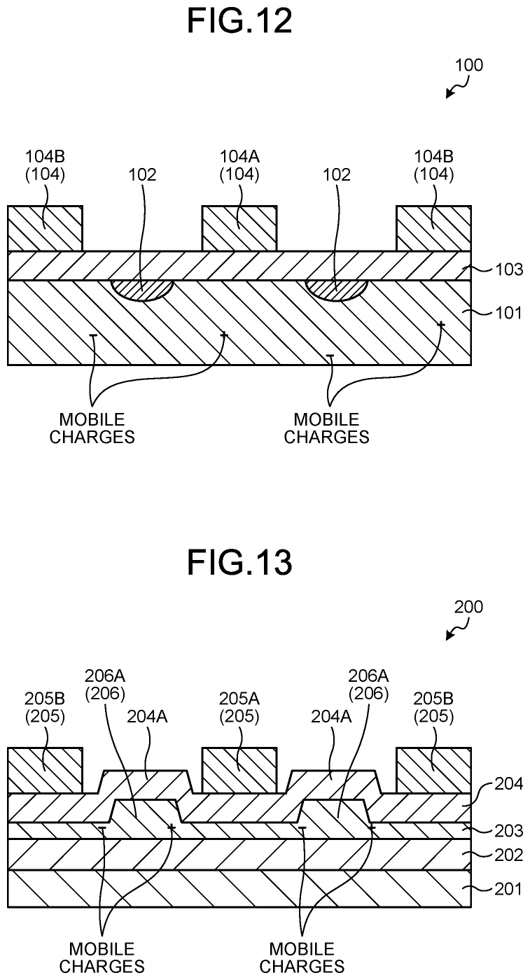

FIG. 10 is a schematic plan view illustrating an example of a configuration of the optical modulator 5 according to the sixth embodiment, and FIG. 11 is a schematic cross-sectional view taken along a line C-C, which illustrates an example of an RF modulation unit 12A of the optical modulator 5 according to the sixth embodiment. Meanwhile, the same components as those of the optical modulator 5 according to the second embodiment are denoted by the same reference symbols, and explanation of the same configurations and operation will be omitted.

The optical modulator 5 is different in that a third sub electrode 71C is provided in addition to the first positive-side sub electrode 71A1, the first negative-side sub electrode 71A2, the second negative-side sub electrode 71B1, and the second positive-side sub electrode 71B2. The first positive-side sub electrode 71A1 and the first negative-side sub electrode 71A2 attract the mobile charges in the LN crystal in the thin-film LN substrate 53 of the DC modulation unit 13 to the vicinities of the first positive-side sub electrode 71A1 and the first negative-side sub electrode 71A2. Further, the first positive-side sub electrode 71A1 and the first negative-side sub electrode 71A2 further attract the mobile charges in the LN crystal in the thin-film LN substrate 53 of the RF modulation unit 12A to the vicinities of the first positive-side sub electrode 71A1 and the first negative-side sub electrode 71A2.

Furthermore, the third sub electrode 71C includes a third negative-side sub electrode 71C1 and a third positive-side sub electrode 71C2. The third negative-side sub electrode 71C1 is a negative-side charge electrode that attracts the positive mobile charges in the LN crystal in the thin-film LN substrate 53 of the RF modulation unit 12A to the vicinity of the third negative-side sub electrode 71C1. The third positive-side sub electrode 71C2 is a positive-side charge electrode that attracts the positive mobile charges in the LN crystal in the thin-film LN substrate 53 of the RF modulation unit 12A to the vicinity of the third positive-side sub electrode 71C2.

The first positive-side sub electrode 71A1 attracts the negative mobile charges in the thin-film LN crystal in the thin-film LN substrate 53 in the RF modulation unit 12A to the vicinity of the first positive-side sub electrode 71A1 in accordance with electrification. As a result, the negative mobile charges are removed from the ribs 60A in the thin-film optical waveguides 60 of the thin-film LN substrate 53 in the RF modulation unit 12A. The first negative-side sub electrode 71A2 attracts the positive mobile charges in the thin-film LN crystal in the thin-film LN substrate 53 in the RF modulation unit 12A to the vicinity of the first negative-side sub electrode 71A2 in accordance with electrification. As a result, the positive mobile charges are removed from the ribs 60A in the thin-film optical waveguides 60 of the thin-film LN substrate 53 in the RF modulation unit 12A.

The third positive-side sub electrode 71C2 attracts the negative mobile charges in the thin-film LN crystal in the thin-film LN substrate 53 in the RF modulation unit 12A to the vicinity of the third positive-side sub electrode 71C2 in accordance with electrification. As a result, the negative mobile charges are removed from the ribs 60A in the thin-film optical waveguides 60 of the thin-film LN substrate 53 in the RF modulation unit 12A. The third negative-side sub electrode 71C1 attracts the positive mobile charges in the thin-film LN crystal in the thin-film LN substrate 53 in the RF modulation unit 12A to the vicinity of the third negative-side sub electrode 71C1 in accordance with electrification. As a result, the positive mobile charges are removed from the ribs 60A in the thin-film optical waveguides 60 of the thin-film LN substrate 53 in the RF modulation unit 12A.

In the RF modulation unit 12A according to the sixth embodiment, the first positive-side sub electrode 71A1 is used to attract the negative mobile charges in the thin-film LN crystal in the thin-film LN substrate 53 to the vicinity of the first positive-side sub electrode 71A1. In the RF modulation unit 12A, the first negative-side sub electrode 71A2 is used to attract the positive mobile charges in the thin-film LN crystal in the thin-film LN substrate 53 to the vicinity of the first negative-side sub electrode 71A2. Furthermore, in the RF modulation unit 12A, the third negative-side sub electrode 71C1 is used to attract the positive mobile charges in the thin-film LN crystal in the thin-film LN substrate 53 to the vicinity of the third negative-side sub electrode 71C1. In the RF modulation unit 12A, the third positive-side sub electrode 71C2 is used to attract the positive mobile charges in the thin-film LN crystal in the thin-film LN substrate 53 to the vicinity of the third positive-side sub electrode 71C2. As a result, the mobile charges are removed from the ribs 60A in the thin-film optical waveguides 60 of the thin-film LN substrate 53. It is possible to stabilize the electric fields in the thin-film optical waveguides 60. It is possible to increase a lifetime of the RF modulation unit 12A.

According to one embodiment of an optical device or the like disclosed in the present application, it is possible to stabilize operation of the optical device.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a rib optical waveguide that is a thin-film lithium niobate (LN) crystal formed of a thin-film LN substrate;
a buffer layer that is laminated on the optical waveguide;
an electrode that is laminated on the buffer layer; and
sub electrodes that are arranged parallel to the electrode on the buffer layer, and attract a charge in the optical waveguide in accordance with electrification.

2. The optical device according to claim 1, wherein
the electrode is a direct current (DC) electrode, and
the sub electrodes are arranged parallel to each other so as to sandwich the DC electrode, and include
a first sub electrode that attracts a negative charge in the optical waveguide; and
a second sub electrode that attracts a positive charge in the optical waveguide.

3. The optical device according to claim 1, wherein the sub electrodes are arranged in a Z-axis direction of orientation of the thin-film LN crystal of the optical waveguide.

4. The optical device according to claim 1, wherein
the electrode includes a plurality of direct current (DC) electrodes that are arranged parallel to each another,
the sub electrodes are arranged parallel to each other so as to sandwich the plurality of DC electrodes and include
a first sub electrode that is arranged parallel to an outermost one DC electrode among the plurality of DC electrodes, and attracts a negative charge in the optical waveguide; and
a second sub electrode that is arranged parallel to another outermost DC electrode among the plurality of DC electrodes, and attracts a positive charge in the optical waveguide.

5. The optical device according to claim 1, wherein
the electrode includes a plurality of direct current (DC) electrodes that are arranged parallel to each another, and
the sub electrodes are arranged parallel to one another so as to sandwich the plurality of DC electrodes and include
a first positive-side sub electrode that attracts a negative charge in the optical waveguide;
a first negative-side sub electrode that attracts a positive charge in the optical waveguide;
a second positive-side sub electrode that attracts a negative charge in the optical waveguide; and
a second negative-side sub electrode that attracts a positive charge in the optical waveguide.

6. The optical device according to claim 2, wherein
the electrode includes a ground electrode and a signal electrode,
the ground electrode is electrically connected to the first positive-side sub electrode and the second positive-side sub electrode, and
the signal electrode is electrically connected to the first negative-side sub electrode and the second negative-side sub electrode.

7. The optical device according to claim 6, wherein each of the signal electrode, the first negative-side sub electrode, and the second negative-side sub electrode includes an electrode pad that electrically connects the signal electrode, the first negative-side sub electrode, and the second negative-side sub electrode by wire bonding.

8. The optical device according to claim 1, wherein a thickness of the thin-film LN substrate below portions on which the the sub electrodes are arranged has a same thickness as the thin-film LN substrate of the optical waveguide.

9. The optical device according to claim 1, further comprising:
opening portions that are opened in the buffer layer in portions in which the sub electrodes are arranged, wherein
the sub electrodes are laminated in the opening portions.

10. The optical device according to claim 1, wherein
the electrode is a radio frequency (RF) electrode, and
the sub electrodes are arranged parallel to each another so as to sandwich the RF electrode and include
a first sub electrode that attracts a negative charge in the optical waveguide; and
a third sub electrode that attracts a positive charge in the optical waveguide.

11. The optical device according to claim 1, wherein
the electrode includes a plurality of radio frequency (RF) electrodes that are arranged parallel to one another,
the sub electrodes are arranged parallel to one another so as to sandwich the plurality of RF electrodes and include
a first positive-side sub electrode that attracts a negative charge in the optical waveguide;
a first negative-side sub electrode that attracts a positive charge in the optical waveguide;
a third positive-side sub electrode that attracts a negative charge in the optical waveguide; and
a third negative-side sub electrode that attracts a positive charge in the optical waveguide.

12. An optical communication apparatus comprising:
a processor that performs signal processing on an electric signal;
a light source that generates light; and
an optical device that modulates light generated by the light source by using the electric signal output from the processor, wherein
the optical device includes
a rib optical waveguide that is a thin-film lithium niobate (LN) crystal formed of a thin-film LN substrate;
a buffer layer that is laminated on the optical waveguide;
an electrode that is laminated on the buffer layer; and
sub electrodes that are arranged parallel to the electrode on the buffer layer, and attract a charge in the optical waveguide in accordance with electrification.
